(19) United States
(12) Patent Application Publication
(10) Pub. No.: US 2015/0363147 A1
(43) Pub. Date: Dec. 17, 2015

(54) COMMUNICATION SYSTEM, IMAGE FORMING APPARATUS, AND COMMUNICATION METHOD

(71) Applicant: Sharp Kabushiki Kaisha, Osaka (JP)

(72) Inventors: Hisashi KUNIHIRO, Osaka-shi (JP); Yasuyuki ISHIGURO, Osaka-shi (JP); Hitoshi NAGAHAMA, Osaka-shi (JP)

(21) Appl. No.: 14/831,950

(22) Filed: Aug. 21, 2015

Related U.S. Application Data
(63) Continuation of application No. 13/340,739, filed on Dec. 30, 2011.

(30) Foreign Application Priority Data
Jan. 13, 2011 (JP) 2011-005338

(51) Int. Cl. G06F 3/12

(52) U.S. Cl. CPC G06F 3/1221; G06F 3/1229

(57) ABSTRACT

A communication system is provided. In a communication system, when consumables mounted on an image forming apparatus main body are determined as greenhouse gas emission right-granted consumables by a computation unit, an image forming apparatus acquires contribution content information regarding greenhouse gas reduction corresponding to emission right allowance information recorded in a recording unit of the consumables from a connection unit and displays the acquired contribution content information on a display unit.

### CROSS-REFERENCE TO RELATED APPLICATION

This application claims priority to Japanese Patent Application No. 2011-005338, which was filed on Jan. 13, 2011, the contents of which are incorporated herein by reference in its entirety.

### BACKGROUND OF THE TECHNOLOGY

1. Field of the Technology

The present technology relates to a communication system capable of identifying the contribution content regarding the greenhouse gas reduction corresponding to the greenhouse gas emission rights granted to the consumables used in an image forming apparatus, an image forming apparatus used therein, and a communication method.

2. Description of the Related Art

As an idea for reducing emissions of greenhouse gases such as carbon dioxide, a carbon offset has been proposed. The carbon offset means activities for compensating for all or a part of the emissions, which is difficult to be reduced even though citizens, companies, governments, and other social entities recognize their own greenhouse gas emissions and make efforts to voluntarily reduce their emissions together, by purchasing a reduction or absorption amount (hereinafter, referred to as “credits”) of greenhouse gas emissions realized in other positions, carrying out projects and activities for reducing and absorbing greenhouse gas emissions in other positions, or the like.

As one carbon offset initiative, there is a trade in greenhouse gas emission rights. For example, emission rights, corresponding to greenhouse gas emission discharged to generate electricity consumed by the image forming apparatus during an operational time period in which consumables are used, are purchased by a manufacturer or a vendor as a credit on behalf of a user and are provided to the user who purchases the consumables. The image forming apparatus identifies consumables having the emission right and manages exchange, recovery, and the like of the identified consumables. For example, as a credit, there is a Kyoto mechanism credit issued on the basis of procedures determined by the Kyoto Protocol.

As a technique relating to greenhouse gas emission trade of the related art, Japanese Unexamined Patent Publication JP-A 2010-197522 proposes a printing device. This printing device counts the number of effective dots included in the print data sent from the host device, calculates a carbon dioxide emission equivalent value corresponding to the counted effective dots, and displays the calculated carbon dioxide emission equivalent value. This is intended to raise user awareness regarding greenhouse gas reduction.

However, in the technique disclosed in JP-A 2010-197522, a user may not confirm information concerning how a user's cost burden relating to the greenhouse gas emission right actually contributes to the greenhouse gas reduction. For this reason, a user is not able to monitor whether or not a user's costs burden relating to the greenhouse gas emission right is used properly. As a result, a user is not able to obtain the satisfaction of contributing to the greenhouse gas reduction even when the user purchases the greenhouse gas emission right-granted consumables and therefore tends to be reluctant to purchase the greenhouse gas emission right-granted consumables.

### SUMMARY OF THE TECHNOLOGY

Accordingly, an object of the technology is to provide a communication system, an image forming apparatus used therein, and a communication method capable of identifying the contribution content regarding greenhouse gas reduction corresponding to the greenhouse gas emission right-granted consumables used in the image forming apparatus and capable of promoting the purchase of the greenhouse gas emission right-granted consumables.

The technology provides a communication system including an image forming apparatus including an image forming apparatus main body and consumables that are removably provided in the image forming apparatus main body and have a recording unit capable of recording emission right allowance information representing that a greenhouse gas emission right is granted; and a server that stores contribution content information representing a contribution content regarding greenhouse gas reduction corresponding to the emission right allowance information, the server being data-communicatively connected with the image forming apparatus,

the image forming apparatus including:
a determination unit that determines whether or not the emission right allowance information is recorded in the recording unit when the consumables are mounted on the image forming apparatus main body,
an acquisition unit that acquires the contribution content information corresponding to emission right allowance information from the server when the determination unit determines that the emission right allowance information is recorded, and
a display unit that displays the contribution content information acquired by the acquisition unit.

The communication system in which an image forming apparatus and a server are data-communicatively connected, is a system to identify the contribution content regarding greenhouse gas reduction. The image forming apparatus includes an image forming apparatus main body and consumables that are removably provided in the image forming apparatus main body and have a recording unit capable of recording emission right allowance information representing that a greenhouse gas emission right is granted. The server stores contribution content information representing a contribution content regarding greenhouse gas reduction corresponding to emission right allowance information.

In such a communication system, the image forming apparatus includes a determination unit, an acquisition unit, and a display unit. The determination unit determines whether or not the emission right allowance information is recorded in the recording unit when the consumables are mounted on the image forming apparatus main body. The acquisition unit acquires the contribution content information from the server if the determination unit determines that the emission right allowance information is recorded. The display unit displays the contribution content information acquired by the acquisition unit.

In the communication system configured as described above, the image forming apparatus displays contribution content information regarding greenhouse gas reduction corresponding to emission right allowance information if it is determined that the emission right allowance information is recorded in the recording unit of the consumables mounted on the image forming apparatus main body. Therefore, it is possible to allow a user to identify the contribution content information and to promote the purchase of the greenhouse gas emission right-granted consumables.

Further, in the communication system, it is preferable that the contribution content information stored in the server is information on planting of trees absorbing the greenhouse gas.

The contribution content information stored in the server is information on planting of trees absorbing the greenhouse gas. In the communication system, since the information on planting of trees is displayed as the contribution content information on the display unit of the image forming apparatus, it is possible to allow a user to identify how a cost burden relating to the greenhouse gas emission right assigned to the consumables is used for greenhouse gas reduction efforts through tree-planting and clearly recognize the contribution content regarding greenhouse gas reduction corresponding to the greenhouse gas emission right.

Further, in the communication system, it is preferable that the information on planting of trees absorbing the greenhouse gas is information on planting of mangroves.

The information on planting of trees is information on planting of mangroves. In the communication system, since the information on planting of mangroves is displayed as contribution content information on the display unit of the image forming apparatus, it is possible to allow a user to check that a cost burden relating to the greenhouse gas emission right assigned to the consumables is used for greenhouse gas reduction efforts through the planting of mangroves absorbing a large amount of greenhouse gases through photosynthesis and clearly recognize the contribution content regarding greenhouse gas reduction corresponding to the greenhouse gas emission right.

Further, in the communication system, it is preferable that the image forming apparatus includes an input unit for inputting an instruction regarding data communication with the server, and

the acquisition unit acquires the contribution content information from the server based on the instruction inputted from the input unit.

In the communication system, the image forming apparatus further includes an input unit for inputting an instruction regarding data communication with the server. The acquisition unit of the image forming apparatus acquires contribution content information from the server based on the instruction inputted from the input unit. As a result, it is possible to allow a user to check the contribution content information regarding greenhouse gas reduction corresponding to emission right allowance information by inputting an instruction using the input unit of the image forming apparatus.

Further, in the communication system, it is preferable that the image forming apparatus and the server are data-communicatively connected via a communication network.

In the communication system, the image forming apparatus and the server are data-communicatively connected via a communication network. As a result, it is possible to allow a user to conveniently and easily receive a service for the greenhouse gas emission right trade.

Further, in the communication system, it is preferable that the recording unit of the consumables is selected from a memory including an integrated circuit, and a one-dimensional or two-dimensional code image obtained by encoding the emission right allowance information.

The recording unit on which the emission right allowance information of the consumables is recorded can be realized by a memory including an integrated circuit and a one-dimensional or two-dimensional code image obtained by encoding the emission right allowance information.

Further, in the communication system, it is preferable that a carbon footprint mark is affixed to the consumables when the determination unit determines that the emission right allowance information is recorded.

In the communication system, a carbon footprint mark is affixed to the consumables when the determination unit of the image forming apparatus determines that the emission right allowance information is recorded. As a result, it is possible to allow a user to recognize the carbon dioxide equivalent value of consumables by checking the carbon footprint mark affixed to the consumables. Therefore, a user can purchase consumables having a high environmental performance, and it is possible to respond to environmental awareness for a user.

The technology provides an image forming apparatus data-communicatively connected to the server which stores contribution content information representing a contribution content regarding greenhouse gas reduction corresponding to emission right allowance information, the image forming apparatus including:

an image forming apparatus main body;

consumables that are removably provided in the image forming apparatus main body and have a recording unit capable of recording emission right allowance information representing that the greenhouse gas emission right is granted;

a determination unit that determines whether or not emission right allowance information is recorded in the recording unit when the consumables are mounted on the image forming apparatus main body;

an acquisition unit that acquires the contribution content information corresponding to the emission right allowance information from the server when the determination unit determines that the emission right allowance information is recorded; and

a display unit that displays the contribution content information acquired by the acquisition unit.

The image forming apparatus includes: an image forming apparatus main body; and consumables that are removably provided in the image forming apparatus main body and have a recording unit capable of recording emission right allowance information which represents that a greenhouse gas emission right is granted, and the image forming apparatus is data-communicatively connected to the server which stores contribution content information representing contribution content regarding greenhouse gas reduction corresponding to emission right allowance information. The image forming apparatus includes: a determination unit; an acquisition unit; and a display unit. The determination unit determines whether or not the emission right allowance information is recorded in the recording unit when the consumables are mounted on the image forming apparatus main body. The acquisition unit acquires the contribution content information from the server when the determination unit determines that the emission right allowance information is recorded. The display unit displays the contribution content information acquired by the acquisition unit.

In the image forming apparatus configured as described above, since the contribution content information regarding greenhouse gas reduction corresponding to emission right allowance information is displayed when it is determined that the emission right allowance information is recorded in the recording unit of consumables mounted on the image forming apparatus main body, it is possible to allow a user to identify the contribution content information and stimulate an attempt to purchase the greenhouse gas emission right-granted consumables.

The technology provides a communication method executed by a communication system in which an image forming apparatus and a server are data-communicatively connected, the image forming apparatus including an image forming apparatus main body and consumables that are removably provided in the image forming apparatus main body and have a recording unit capable of recording emission right allowance information which represents that a greenhouse gas emission right is granted, and the server storing contribution content information representing a contribution content regarding greenhouse gas reduction corresponding to emission right allowance information, the communication method including:

a determination step of determining whether or not emission right allowance information is recorded in the recording unit when the consumables are mounted on the image forming apparatus main body;

an acquisition step of acquiring the contribution content information from the server when it is determined that the emission right allowance information is recorded in the determination step; and

a display step of displaying the contribution content information acquired in the acquisition step.

The communication method is executed by a communication system in which the image forming apparatus and the server are data-communicatively connected. The image forming apparatus includes an image forming apparatus main body and consumables that are removably provided in the image forming apparatus main body and have a recording unit capable of recording emission right allowance information which represents that the greenhouse gas emission right is granted. The server stores contribution content information representing a contribution content regarding greenhouse gas reduction corresponding to the emission right allowance information.

The communication method executed by such a communication system includes a determination step, an acquisition step, and a display step. In the determination step, it is determined whether or not emission right allowance information is recorded in the recording unit when the consumables are mounted on the image forming apparatus main body. In the acquisition step, the contribution content information is acquired from the server when it is determined in the determination step that the emission right allowance information is recorded. In the display step, the contribution content information acquired in the acquisition step is displayed.

In the communication method including steps described above, since the image forming apparatus displays the contribution content information regarding greenhouse gas reduction corresponding to emission right allowance information when it is determined that the emission right allowance information is recorded in the recording unit of consumables mounted on the image forming apparatus main body, it is possible to allow a user to check the contribution content information and stimulate an attempt to purchase the greenhouse gas emission right-granted consumables.

### BRIEF DESCRIPTION OF THE DRAWINGS

Other and further objects, features, and advantages of the technology will be more explicit from the following detailed description taken with reference to the drawings wherein:

FIG. 1 is a diagram schematically illustrating a configuration of a communication system according to an embodiment;

FIG. 2 is a perspective diagram illustrating appearance of an image forming apparatus;

FIG. 3 is a block diagram illustrating a configuration of the image forming apparatus;

FIGS. 4A and 4B are diagrams illustrating appearance of a manipulation panel;

FIG. 5 is a diagram illustrating an example of a selection screen;

FIG. 6 is a diagram illustrating an example of a consumables list screen;

FIG. 7 is a diagram illustrating an example of a display screen of contribution content information regarding greenhouse gas reduction corresponding to the greenhouse gas emission right;

FIG. 8 is a diagram illustrating an example of a pledge application screen;

FIG. 9 is a diagram illustrating an example of a pledge receiving screen; and

FIG. 10 is a flowchart illustrating a processing sequence for a confirmation process of the greenhouse gas emission right contribution content executed in the communication system.

### DETAILED DESCRIPTION

Now referring to the drawings, preferred embodiments are described below.

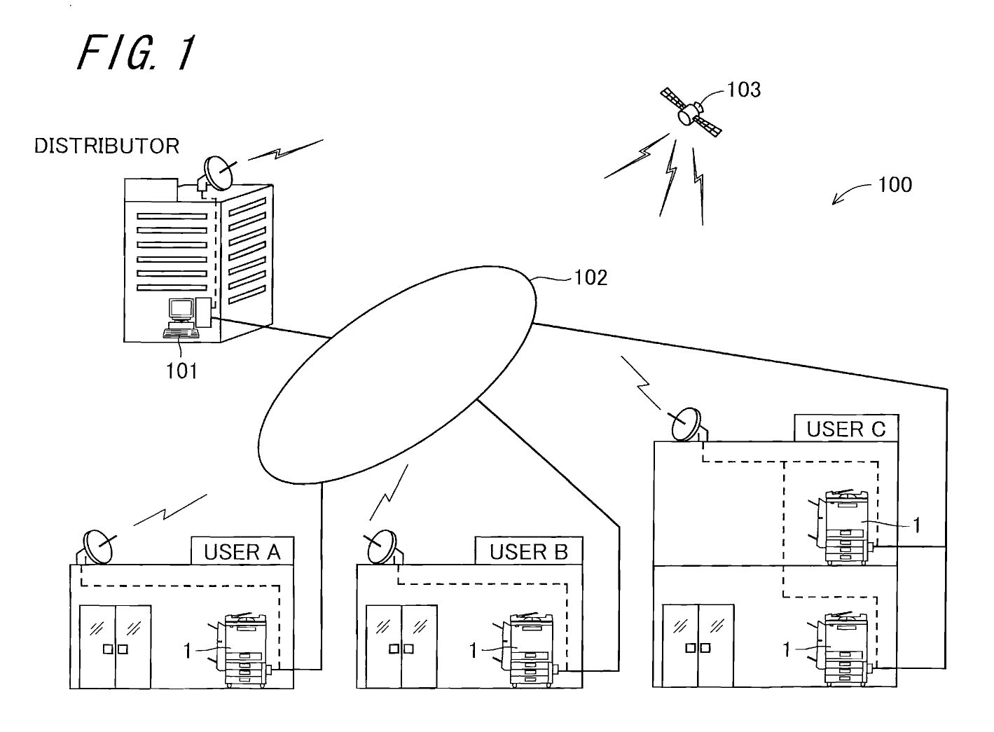

FIG. 1 is a diagram schematically illustrating a configuration of a communication system 100 according to an embodiment. The communication method according to the embodiment is executed by the communication system 100. The communication system 100 includes an image forming apparatus 1 and a server 101 and is a system for identifying a contribution content regarding greenhouse gas reduction. Although the sever 101 is singular according to the embodiment, the image forming apparatus 1 may be either singular or plural.

The image forming apparatus 1 and the server 101 are connected with a local area network (hereinafter, referred to as a “LAN”) 102, and information can be sent and received between the server 101 and the image forming apparatus 1. The communication between the image forming apparatus 1 and the server 101 is not limited to the LAN 102, but may also be available in communication networks such as the Internet, communication lines via a satellite communication apparatus 103, and Intranet, Extranet, ISDN, VAN, CATV communication networks, virtual private networks, telephone networks, mobile communication networks, and satellite communication networks and the like. In addition, a transmission medium of the communication network is not particularly limited, but may include, for example, a wired line such as IEEE1394, USB, power line communication, cable TV communication, telephone lines, ADSL, an infrared radiation such as IrDA or Remote controller, wireless communication such as Bluetooth (registered trademark), 802.11 wireless, HDR, cellular phone networks, satellite communication network, and digital terrestrial networks. In addition, the technology may be realized in the form of computer data signals embedded in carrier waves by which the program codes are embodied as the electronic transmission.

Hereinafter, it is assumed that information can be sent and/or received using an e-mail, facsimile communication, or the like as well as in the form of directly sending and/or receiving information between the image forming apparatus 1 and the server 101 using the LAN 102.

The server 101 is provided in manufacturers of the image forming apparatus 1, vendors, distributors, lease stores, or cloud providers which provides a cloud computing service. The image forming apparatus 1 is provided in user's companies, offices, stores, and the like under the environment where a user can use the image forming apparatus 1.

The server 101 has a server storage unit (not shown) for storing contribution content information which represents the contribution content regarding the greenhouse gas reduction corresponding to the emission rights allowance information recorded in a recording unit mounted on the consumables which are removably provided in the image forming apparatus main body 3 of the image forming apparatus 1. In response to a request for contribution content information from the image forming apparatus 1, the server 101 reads from the server storage unit the contribution content information corresponding to the greenhouse gas emission right granted to the consumables used in the requesting image forming apparatus 1, and sends the read contribution content information to the image forming apparatus 1.

The contribution content information stored in the server storage unit of the server 101 may include information on the planting of trees absorbing greenhouse gases such as mangrove, information on renewable energy generation projects such as photovoltaic power generation, wind power generation, geothermal power generation, hydropower generation, tidal power generation, power generation by ocean thermal energy conversion, and solar-thermal power generation, information on ocean carbon dioxide absorption projects in which carbon dioxide in the atmosphere is dissolved and accumulated in the seabed or deep ocean by marine life, information on soil carbon dioxide absorption projects for absorbing carbon dioxide by dead plants or dead organisms, information on carbon dioxide storing projects by geological isolation or ocean isolation, and the like. According to the embodiment, information on the mangrove-planting as the contribution content information is stored in the server storage unit of the server 101.

For example, the consumables are a print toner cartridge. This consumables are provided with a recording unit capable of recording emission right allowance information representing that the greenhouse gas emission right is granted. Here, the greenhouse gas emission right granted to the consumables is provided to a user who purchases the consumables from the manufacturer or a vendor of the consumables, who purchases, as a credit, the right corresponding to the greenhouse gas discharged to generate the power consumed while the image forming apparatus 1 is operated using the consumables on behalf of a user. The recording unit provided in the consumables may include a memory such as a customer replaceable unit memory (CRUM) including an IC chip having an integrated circuit (IC), and IC tags, a one-dimensional code image such as encoded barcodes obtained by encoding the emission right allowance information, a two-dimensional code image such as QR codes (registered trademark), and the like.

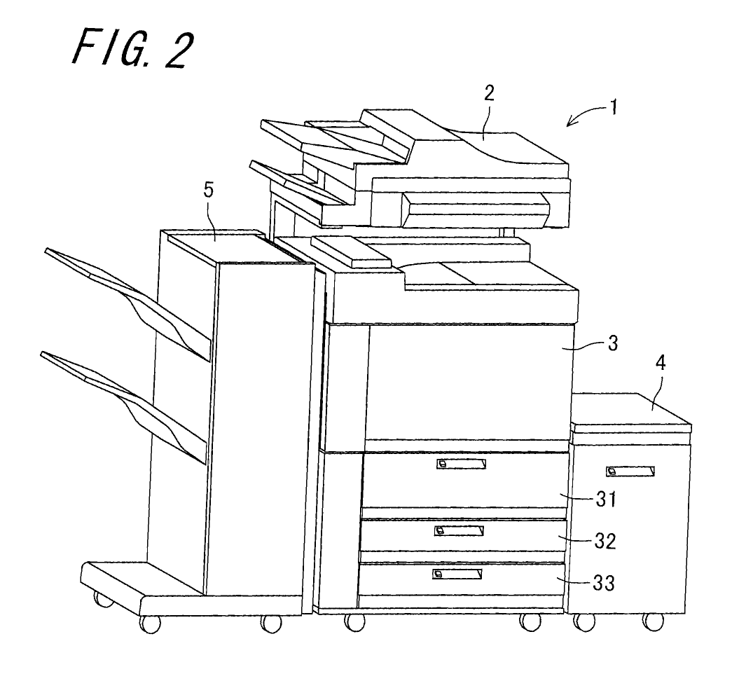

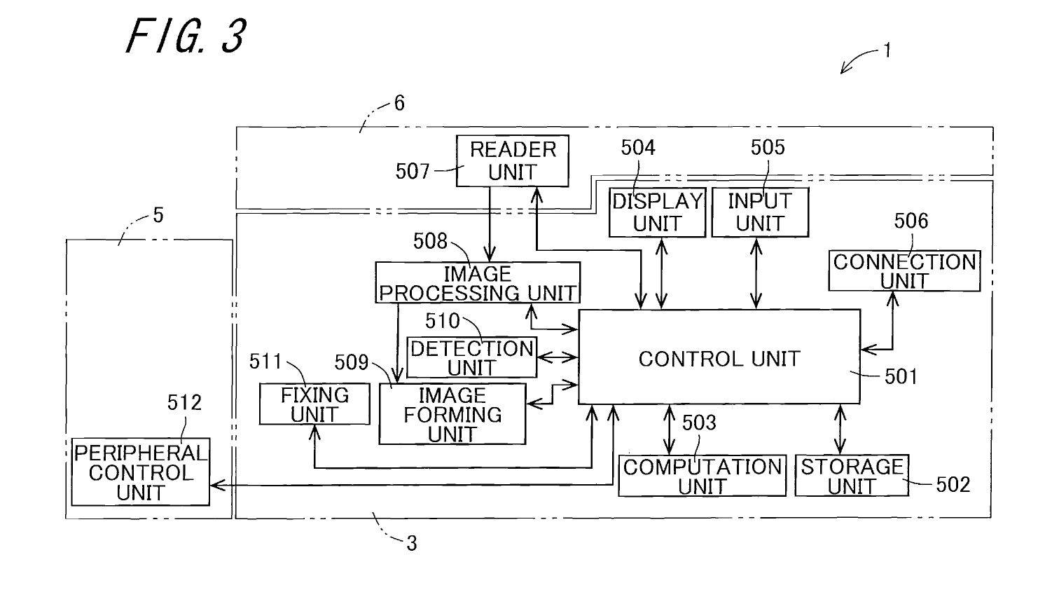

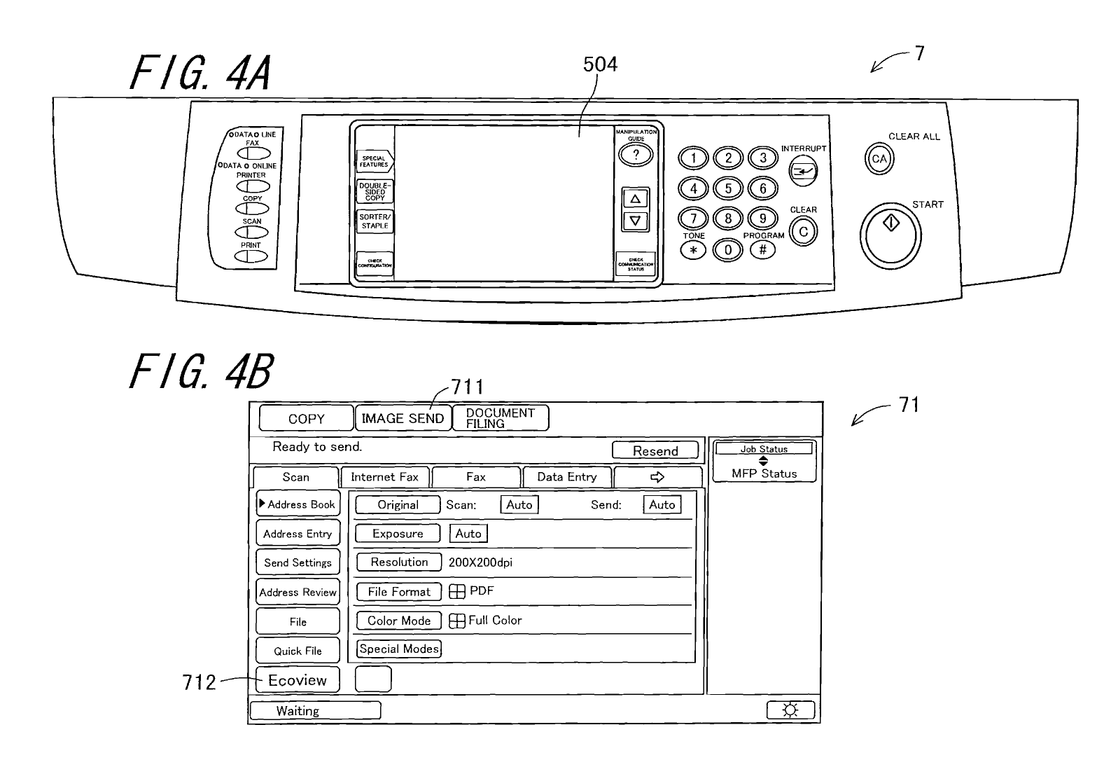

FIG. 2 is a perspective diagram illustrating appearance of the image forming apparatus 1. FIG. 3 is a block diagram illustrating a configuration of the image forming apparatus 1. FIGS. 4A and 4B are diagrams illustrating appearance of the manipulation panel 7. The image forming apparatus 1 includes a document feeder 2, an image forming apparatus main body 3, a mass sheet feeder 4, a sorter 5, a scanner 6, a manipulation panel 7, and sheet feeders 31, 32, and 33.

The document feeder 2 feeds the original to the scanner 6 one by one. The image forming apparatus main body 3 includes a control unit 501, a storage unit 502, a computation unit 503, a display unit 504, an input unit 505, a connection unit 506, a reader unit 507, an image processing unit 508, an image formation unit 509, a detection unit 510, and a fixing unit 511. The image forming apparatus main body 3 prints image information read by the scanner 6, image information acquired via the LAN 102, or image information read from the removable recording medium, and the like.

The control unit 501 is configured by, for example, a central processing unit (hereinafter, referred to as a “CPU”), and controls the computation unit 503, the display unit 504, the input unit 505, the connection unit 506, the image processing unit 508, the image formation unit 509, the detection unit 510, the fixing unit 511, the document feeder 2, the mass sheet feeder 4, the sorter 5, the scanner 6, the manipulation panel 7, and the sheet feeders 31, 32, and 33 by executing the program stored in the storage unit 502.

The storage unit 502 is configured by, for example, a storage device such as a semiconductor memory, an HDD, and a Blu-ray Disc, and stores a program which is executed by the CPU and information required to execute the program by the CPU. In addition, the storage unit 502 stores in advance emission right allowance information of the consumables available in the image forming apparatus 1. The information stored in the storage unit 502 is written and read by the CPU.

The detection unit 510 detects emission right allowance information recorded in the recording unit provided in the consumables when the consumables are mounted on the image forming apparatus main body 3.

The computation unit 503 as a determination unit determines whether or not the consumables are regular consumables having the greenhouse gas emission right by determining whether or not the emission right allowance information is recorded on the recording unit of the consumables based on the emission right allowance information detected by the detection unit 510. More particularly, the computation unit 503 determines whether or not the consumables mounted on the image forming apparatus main body 3 are regular consumables having the greenhouse gas emission right by comparing the emission right allowance information detected by the detection unit 510 and the emission right allowance information stored in advance in the storage unit 502. The computation unit 503 also serves as a communication permission unit and allows data communication with the server 101 when the consumables mounted on the image forming apparatus main body 3 are determined as the regular consumables having the greenhouse gas emission right.

A carbon footprint mark is affixed to the consumables determined as the regular consumables having the greenhouse gas emission right subject to the consumables mounted on the image forming apparatus main body 3 by the computation unit 503. As a result, it is possible to allow a user to recognize the carbon dioxide equivalent value of consumables by checking the carbon footprint mark affixed to the consumables. Therefore, a user can purchase consumables having a high environmental performance, and it is possible to respond to the environmental awareness of the user.

In addition, the carbon footprint mark is a mark indicating that the verification under carbon footprint system is received. The carbon footprint system converts the emission amount of greenhouse gas to carbon dioxide (hereinafter, “CO₂”) emitted over the entire life cycle from raw materials acquisition to disposal and recycling of products and services and means the structure to display a simple and easy way such products and services.

There are six types of greenhouse gases as the target of the Kyoto Protocol including “CO₂” methane (hereinafter, referred to as “CH₄”), nitrous oxide (hereinafter, referred to as “N₂O”), hydrofluorocarbons (hereinafter, referred to as “HFCs”), perfluorocarbons (hereinafter, referred to as “PFCs”), and sulfur hexafluoride (hereinafter, referred to as “SF₆”). A letter “CO₂” and a CO₂ equivalent value (kg) are indicated in the carbon footprint mark. The CO₂ equivalent value is obtained by converting the greenhouse gas emission amount in the entire life cycle of the consumables into the CO₂ emission amount. In addition, a description of the carbon footprint mark may be displayed in the carbon footprint mark.

The emission amount of CO₂ is calculated by using a general formula determined in the carbon footprint system. The general formula is calculated by utilizing a life cycle assessment (LCA) technique and can be expressed as the following formula (1).

emission amount of CO₂=Σ(amount of activity i×CO₂ emissions per unit) (1)

In the formula, i denotes an amount of activity (process) of a life cycle phase from raw material acquisition to disposal and recycling.

The life cycle phase and the amount of activity may correspond to the following (a) to (e):

(a) the amount of activity in the raw materials acquisition phase is a material use amount;

(b) the amount of activity in the production phase is an assembly weight and a power consumption during production;

(c) the amount of activity in the distribution phase is a transport amount (a product of a transportation distance, a loading ratio, and a truck loading amount);

(d) the amount of activity in the use and maintenance phase is a power consumption during the use; and

(e) the amount of activity in the disposal and recycling phase is a landfill weight and a recycling weight.

As the unit of the CO₂ emission amount, units representing weights such as kg, g, and t is used.

The display unit 504 is a display device provided on the manipulation panel 7, and is configured by, for example, a touch panel. The display unit 504 displays information instructed from the control unit 501. FIG. 4A is a front view of the manipulation panel 7. In the manipulation panel 7, the display unit 504 is disposed in the center thereof, and a plurality of manipulation buttons are disposed in both sides of the display unit 504.

The input unit 505 is configured by manipulation buttons disposed in the manipulation panel 7 and manipulation icons provided on a display screen of the display unit 504. The input unit 505 sends, to the control unit 501, the information indicating manipulation buttons and icons manipulated when the manipulation buttons and icons are manipulated. The information indicating manipulation icons is position information of a user's finger on the display screen. However, since the control unit 501 recognizes the position of the manipulation icon on the display screen, it is possible to recognize which manipulation icon is manipulated based on the information on a user's finger position received from the input unit 505.

The connection unit 506 is a recording device which mounts thereon a removable memory medium such as a universal serial bus (USB) memory or a memory card and performs writing and reading for the information to/from the removable memory medium, and is a communication device for sending and/or receiving information to/from the server 101. The connection unit 506 sends the information received from the server 101 and the information read from the removable memory medium to the control unit 501, writes the information received from the control unit 501 to the removable memory medium, or sends it to the server 101.

The image processing unit 508 converts the image information received from the reader unit 507 of the scanner 6 or the image information received from the control unit 501 into the print format instructed from the control unit 501 and sends it to the image formation unit 509. Examples of the print format include a print size, a resolution, and a color. The image formation unit 509 prints image information received from the image processing unit 508 on the sheet as an image. The fixing unit 511 fixes the image printed on the sheet by the image formation unit 509.

The mass sheet feeder 4 holds a lot of sheets for printing and sequentially feeds the sheet to the image forming apparatus main body 3 according to the instruction from the image forming apparatus main body 3. The sorter 5 includes a peripheral control unit 512 and sorts and discharges the printed sheets. The peripheral control unit 512 sorts the printed sheets in the image forming apparatus main body 3 according to the instruction from the control unit 501 and discharges them to a target stacker among a plurality of stackers. The sorter 5 is a peripheral device, and a post processing device such as a finisher may be used as the peripheral device instead of the sorter 5.

The scanner 6 includes the reader unit 507 and reads the original fed from the document feeder 2 by the reader unit 507. The reader unit 507 reads the original and sends the image information representing an image of read original to the image processing unit 508 or the control unit 501. The sheet feeders 31, 32, and 33 can hold sheets having different sizes, and any one of sheet feeders 31, 32, and 33 feeds the sheet of the print size instructed from the image forming apparatus main body 3 to the image forming apparatus main body 3.

FIG. 4B is a diagram illustrating an example of an IMAGE SEND initial screen 71. The control unit 501 causes the display screen of the display unit 504 to display main menu icons including an IMAGE SEND icon 711 as an initial screen when both the image forming apparatus 1 and the server 101 are powered up and operable. The control unit 501 causes the display unit 504 to display the IMAGE SEND initial screen 71 when a user manipulates the IMAGE SEND icon 711 out of the main menu icons.

The main menu icons also appear at the top of the IMAGE SEND initial screen 71. The IMAGE SEND initial screen 71 displays a plurality of submenu icons in the left edge thereof. The control unit 501 performs control such that a selection screen 72 is displayed on the display unit 504 when an Ecoview icon 712 is manipulated out of the plurality of submenu icons.

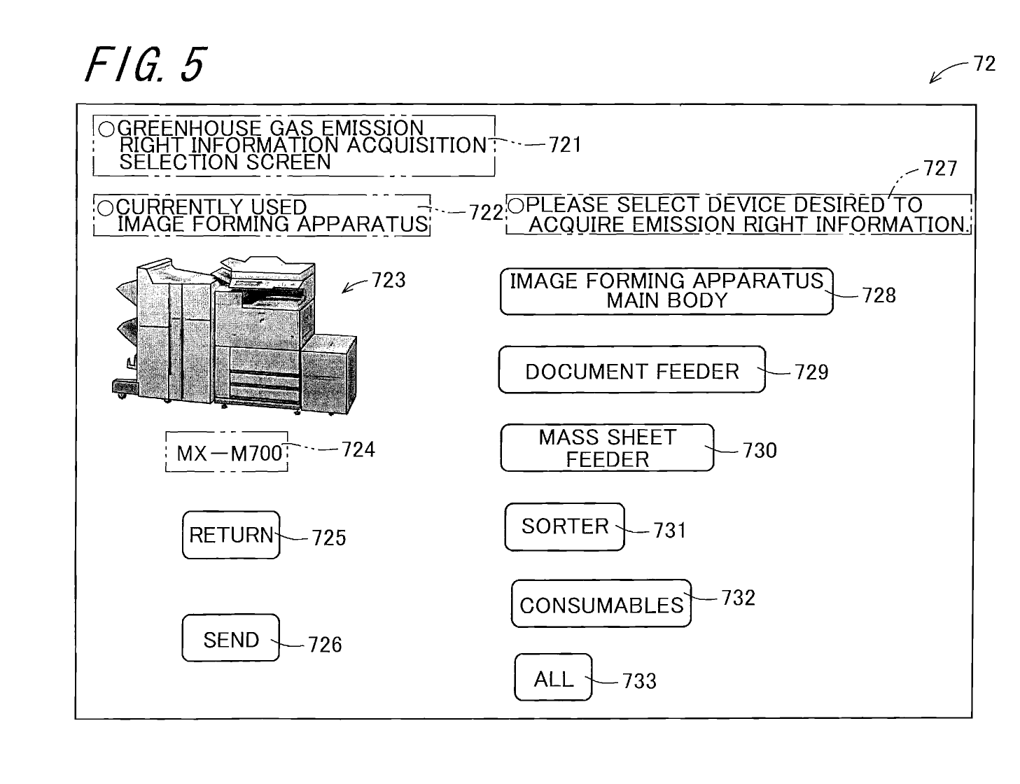

FIG. 5 is a diagram illustrating an example of the selection screen 72. The selection screen 72 is a screen for selecting the device desired to acquire the contribution content information from the server 101. The selection screen 72 includes a screen title field 721, a target device title field 722, a target device image field 723, a target device type field 724, a “RETURN” icon 725, a “SEND” icon 726, a device selection message field 727, a “IMAGE FORMING APPARATUS MAIN BODY” icon 728, a “DOCUMENT FEEDER” icon 729, a “MASS SHEET FEEDER” icon 730, a “SORTER” icon 731, a “CONSUMABLES” icon 732, and an “ALL” icon 733.

The screen title field 721 is a field for indicating the title of the selection screen 72. In FIG. 5, “o GREENHOUSE GAS EMISSION RIGHT INFORMATION ACQUISITION SELECTION SCREEN” is illustrated. The target device title field 722 is a field that displays the image forming apparatus 1 currently used, and in FIG. 5, “o CURRENTLY USED IMAGE FORMING APPARATUS” is illustrated. The target device image field 723 is a field that displays an image showing the appearance of the image forming apparatus 1. The target device type field 724 is a field that displays a type of the image forming apparatus 1, and in FIG. 5, “MX-M700” is illustrated. The “RETURN” icon 725 is a manipulation icon for going back to the previous screen. The “SEND” icon 726 is a manipulation icon for sending the device information to the server 101 indicated by the icon representing the device in the manipulation icon chosen from the manipulation icons that appear below the device selection message field 727.

The device selection message field 727 is a field that displays a message for prompting a user to select a device desired to acquire the contribution content information, and in FIG. 5, “o PLEASE SELECT DEVICE DESIRED TO ACQUIRE EMISSION RIGHT INFORMATION” is illustrated. The “IMAGE FORMING APPARATUS MAIN BODY” icon 728, “DOCUMENT FEEDER” icon 729, “MASS SHEET FEEDER” icon 730, “SORTER” icon 731, “CONSUMABLES” icon 732, and “ALL” icon 733 are displayed below the device selection message field 727 as selectable manipulation icons.

The “IMAGE FORMING APPARATUS MAIN BODY” icon 728 is a manipulation icon for instructing selection of “IMAGE FORMING APPARATUS MAIN BODY”. The “DOCUMENT FEEDER” icon 729 is a manipulation icon for instructing selection of “DOCUMENT FEEDER”. The “MASS SHEET FEEDER” icon 730 is a manipulation icon for instructing selection of “MASS SHEET FEEDER”. The “SORTER” icon 731 is a manipulation icon for instructing selection of “SORTER”. The “CONSUMABLES” icon 732 is a manipulation icon for instructing selection of “CONSUMABLES”. The “ALL” icon 733 is a manipulation icon for instructing selection of all devices such as “IMAGE FORMING APPARATUS MAIN BODY”, “DOCUMENT FEEDER”, “MASS SHEET FEEDER”, “SORTER”, and “CONSUMABLES”.

The information displayed as the IMAGE SEND initial screen 71 is stored in the storage unit 502 in advance, and the control unit 501 reads the information from the storage unit 502 and sends the read information to the display unit 504 to display it.

According to the embodiment, in a case where the consumables mounted on the image forming apparatus main body 3 are determined as the regular consumables having the greenhouse gas emission right by the computation unit 503, and the data communication with the server 101 is permitted, and, for example, when a user wants to acquire the contribution content information regarding the greenhouse gas reduction corresponding to the greenhouse gas emission right granted to the consumables, the “CONSUMABLES” icon 732 is selected, the “SEND” icon 726 is manipulated, and the control unit 501 is informed of the selection of the “CONSUMABLES” icon 732 and manipulation of the “SEND” icon 726 from the input unit 505, the control unit 501 requests the contribution content information for the consumables through the connection unit 506 to the server 101.

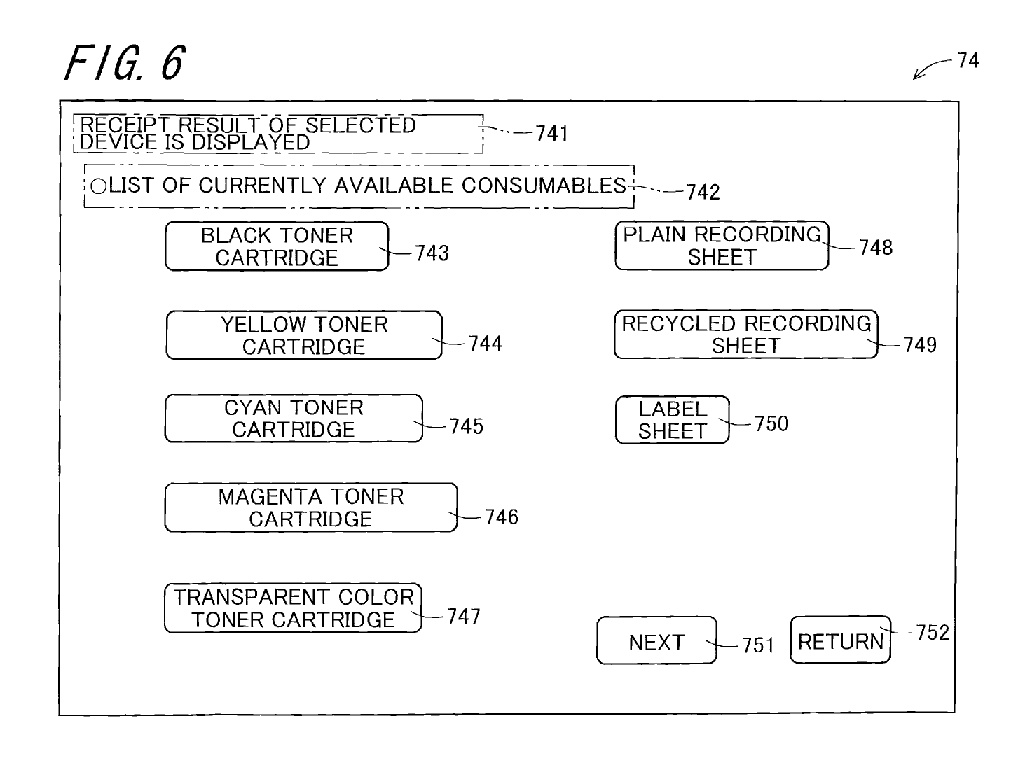

When the contribution content information of consumables is requested from the image forming apparatus 1, the server 101 reads available consumables list information from the image forming apparatus 1 stored in the server storage unit and sends the read consumables list information to the image forming apparatus 1. The control unit 501 stores the received consumables list information in the storage unit 502 as well as causes the display unit 504 to display consumables list screen 74 as shown in FIG. 6 when the consumables list information is received from the server 101 through the connection unit 506. The control unit 501 and the connection unit 506 are an acquisition unit.

FIG. 6 is a diagram illustrating an example of the consumables list screen 74. The consumables list screen 74 is a screen that displays a list of consumables available in the image forming apparatus 1. The consumables list screen 74 includes a receipt result message field 741, a target consumables title field 742, a “BLACK TONER CARTRIDGE” icon 743, a “YELLOW TONER CARTRIDGE” icon 744, a “CYAN TONER CARTRIDGE” icon 745, a “MAGENTA TONER CARTRIDGE” icon 746, a “TRANSPARENT COLOR TONER CARTRIDGE” icon 747, a “PLAIN RECORDING SHEET” icon 748, a “RECYCLED RECORDING SHEET” icon 749, a “LABEL SHEET” icon 750, a “NEXT” icon 751, and a “RETURN” icon 752.

The receipt result message field 741 is a field for indicating the receipt result of consumables list information from the server 101, and in FIG. 6, “RECEIPT RESULT OF SELECTED DEVICE IS DISPLAYED” is illustrated. In addition, when it is determined that the consumables mounted on the image forming apparatus main body 3 are not granted a greenhouse gas emission right by the computation unit 503 and the data communication with the server 101 is not permitted, in the receipt result message field 741, an information message, for example, “CONSUMABLES TO WHICH A GREENHOUSE GAS EMISSION RIGHT ARE NOT GRANTED ARE MOUNTED”.

The target consumables title field 742 is a field for indicating that a list of consumables is available in the image forming apparatus 1, and in FIG. 6, “o LIST OF CURRENTLY AVAILABLE CONSUMABLES” is illustrated. The “BLACK TONER CARTRIDGE” icon 743, the “YELLOW TONER CARTRIDGE” icon 744, the “CYAN TONER CARTRIDGE” icon 745, the “MAGENTA TONER CARTRIDGE” icon 746, the “TRANSPARENT COLOR TONER CARTRIDGE” icon 747, the “PLAIN RECORDING SHEET” icon 748, the “RECYCLED RECORDING SHEET” icon 749, the “LABEL SHEET” icon 750, the “NEXT” icon 751, and the “RETURN” icon 752 are displayed below the target consumables title field 742 as the selectable manipulation icons.

The “BLACK TONER CARTRIDGE” icon 743 is a manipulation icon for instructing selection of “BLACK TONER CARTRIDGE”. The “YELLOW TONER CARTRIDGE” icon 744 is a manipulation icon for instructing selection of “YELLOW TONER CARTRIDGE”. The “CYAN TONER CARTRIDGE” icon 745 is a manipulation icon for instructing selection of “CYAN TONER CARTRIDGE.” The “MAGENTA TONER CARTRIDGE” icon 746 is a manipulation icon for instructing selection of “MAGENTA TONER CARTRIDGE.” The “TRANSPARENT COLOR TONER CARTRIDGE” icon 747 is a manipulation icon for instructing selection of “TRANSPARENT COLOR TONER CARTRIDGE.” The “PLAIN RECORD SHEET” icon 748 is a manipulation icon for instructing selection of “PLAIN RECORDING SHEET.” The “RECYCLED RECORDING SHEET” icon 749 is a manipulation icon for instructing selection of “RECYCLED RECORDING SHEET.” The “LABEL SHEET” icon 750 is a manipulation icon for instructing selection of “LABEL SHEET.” The “NEXT” icon 751 is a manipulation icon for advancing to the immediately subsequent screen. The “RETURN” icon 752 is a manipulation icon for returning to the immediately previous screen.

According to the embodiment, for example, in a case where a user hopes to acquire the contribution content information regarding greenhouse gas reduction corresponding to the greenhouse gas emission right granted to the black toner cartridge out of the consumables, a user selects the “BLACK TONER CARTRIDGE” icon 743 and then manipulates the “NEXT” icon 751. The control unit 501 requests the contribution content information for the black toner cartridge through the connection unit 506 when the control unit 501 is informed of the selection of the “BLACK TONER CARTRIDGE” icon 743 and the manipulation of the “NEXT” icon 751 by the input unit 505 to the server 101.

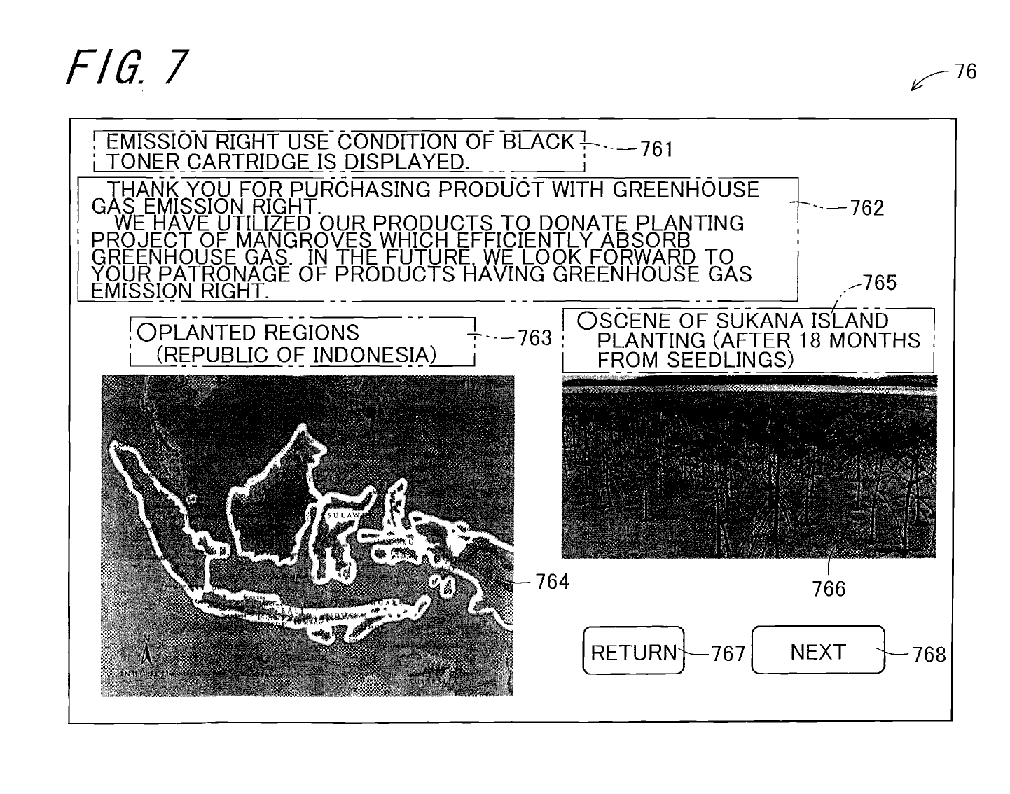

The server 101 reads the contribution content information stored in the server storage unit and sends the read contribution content information to the image forming apparatus 1 when the contribution content information is requested from the image forming apparatus 1. When the control unit 501 receives contribution content information from the server 101 through the connection unit 506, the control unit 501 stores the received contribution content information in the storage unit 502 and causes the display unit 504 to display the display screen 76 of the contribution content information as shown in FIG. 7.

FIG. 7 is a diagram illustrating an example of the display screen 76 of the contribution content information regarding greenhouse gas reduction corresponding to the greenhouse gas emission right. According to the embodiment, the related information on mangrove-planting as the contribution content information is displayed on the display unit 504. The display screen 76 of the contribution content information includes a display content message field 761, a contribution content guidance message field 762, a first contribution content image title field 763, a first contribution content image field 764, a second contribution content image title field 765, a second contribution content image field 766, a “RETURN” icon 767, and a “NEXT” icon 768.

The display content message field 761 is a field for indicating the description about the display content displayed on the display screen 76 of the contribution content information, and in FIG. 7, “EMISSION RIGHT USE CONDITION OF BLACK TONER CARTRIDGE IS DISPLAYED” is illustrated. The contribution content guidance message field 762 is a field for indicating the description regarding the contribution content information corresponding to the greenhouse gas emission right granted to the black toner cartridge.

The first contribution content image title field 763 is a field for indicating the image title displayed in the first contribution content image field 764, and in FIG. 7, “o PLANTED REGIONS (REPUBLIC OF INDONESIA)” is illustrated as a title of the region where the mangroves are planted. The first contribution content image field 764 is a field for indicating the contribution content information as an image, and in FIG. 7, the mangrove planting region is illustrated as an image. The second contribution content image field 765 is a field for indicating the image title displayed in the second contribution content image field 766, and in FIG. 7, “o Scene of Sukana island planting (after 18 months from seedlings)” is illustrated as the title for showing the scene of mangrove-planting. The second contribution content image field 766 is a field for indicating the contribution content information as an image, and in FIG. 7, the scene of mangrove-planting is illustrated as an image. In addition, the image data used as an example of the image displayed in the first contribution content image field 764 and the second contribution content image field 766 is citation from the web page YL invest Ltd in FIG. 7.

On the display screen 76 of contribution content information, more specific information describing the contribution content regarding greenhouse gas reduction may be displayed. For example, information can be mentioned to explain the details of the mangroves as the detailed information. For example, information describing the details of the mangroves will be described as follows.

<Information Describing Details of the Mangrove>

“Mangroves” is a generic term for plants that grow in the intertidal zone where seawater mixes with fresh water. There is no tree called a mangrove. There are more than 100 species of mangroves in the world and they are distributed in many tropical countries near the equator. Most of the mangroves are distributed in the Southeast Asia, believed to be their place of origin, but now the distribution has spread around the world. Most grow in the tropics and subtropics between latitude 30° north and latitude 30° south, but some species having strong vitality are also present in temperate areas. Mangroves are called the “lungs of the earth”. The rainforest has the largest fixed amount of carbon dioxide absorption among forests; however, the fixed amount of carbon dioxide absorption of mangroves surpasses the rainforest with regard to amount of absorption per 1 ha. For example, 10 tons of carbon dioxide will be absorbed over 30 years by planting 40 mangroves. The annual carbon dioxide emission per Japanese person is about 9.8 tons, and it is possible to offset such carbon dioxide emissions by planting 40 mangroves every year.

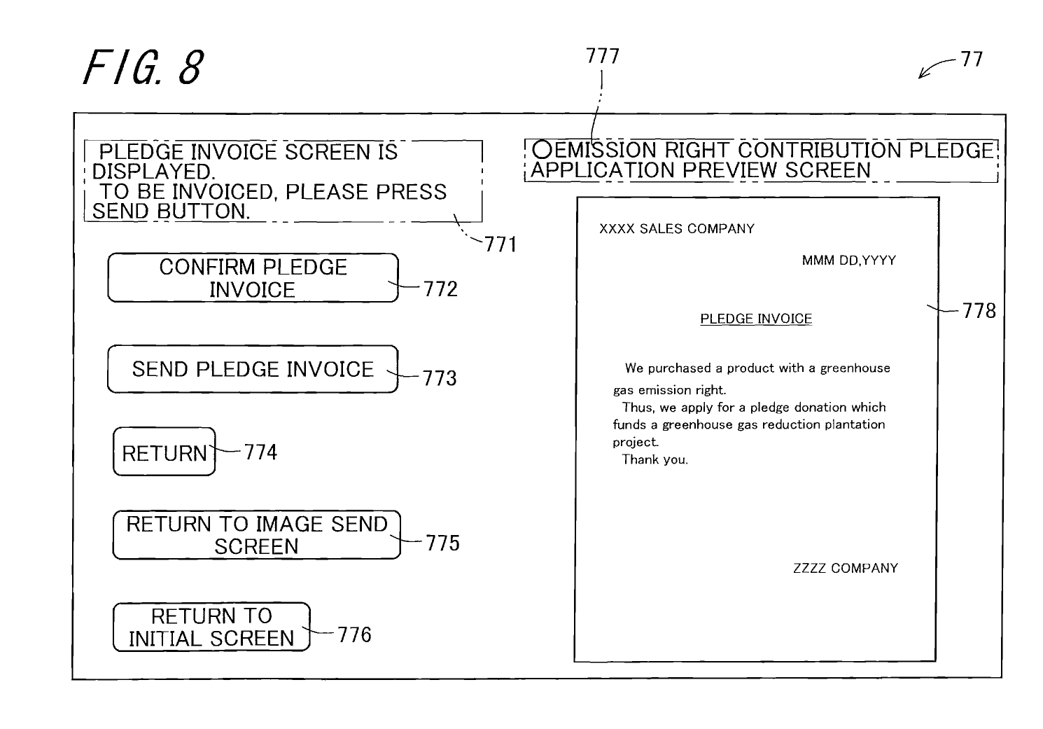

The “RETURN” icon 767 is a manipulation icon for returning to the previous screen. The “NEXT” icon 768 is a manipulation icon for moving to the subsequent screen. The control unit 501 performs control such that a pledge application screen 77 as shown in FIG. 8 is displayed on the display unit 504 when a user manipulates the “NEXT” icon 768.

FIG. 8 is a diagram illustrating an example of the pledge application screen 77. The pledge application screen 77 includes a manipulation guidance field 771, a “CONFIRM PLEDGE INVOICE” icon 772, a “SEND PLEDGE INVOICE” icon 773, a “RETURN” icon 774, a “RETURN TO IMAGE SEND SCREEN” icon 775, a “RETURN TO INITIAL SCREEN” icon 776, a pledge invoice preview title field 777, and a pledge invoice preview screen field 778.

A manipulation guidance field 771 is a field for indicating a message for guiding manipulation in the pledge application screen 77, and in FIG. 8, the message “PLEDGE INVOICE SCREEN IS DISPLAYED. TO BE INVOICED, PLEASE PRESS SEND BUTTON.” is illustrated. The “CONFIRM PLEDGE INVOICE” icon 772 is a manipulation icon for confirming the pledge invoice content of the preview image displayed in the pledge invoice preview screen field 778. The “SEND PLEDGE INVOICE” icon 773 is a manipulation icon for sending a confirmed pledge invoice to the server 101. The “RETURN” icon 774 is a manipulation icon for returning to the previous screen. The “RETURN TO IMAGE SEND SCREEN” icon 775 is a manipulation icon for returning to the IMAGE SEND initial screen 71. The “RETURN TO INITIAL SCREEN” icon 776 is a manipulation icon for returning to the initial screen displayed initially at operable state after the power-on.

The pledge invoice preview title field 777 is a field for indicating the title of the preview image displayed on the pledge invoice preview screen field 778, and in FIG. 8, “o EMISSION RIGHT CONTRIBUTION PLEDGE APPLICATION PREVIEW SCREEN” is illustrated. The pledge invoice preview screen field 778 is a screen field to show the pledge invoice as a preview image. The preview image displayed in the pledge invoice preview screen field 778 of FIG. 8 shows a destination “XXXX SALES COMPANY,” an invoice date “MMM DD, YYYY” a document title “PLEDGE INVOICE,” a body “We purchased a product with a greenhouse gas emission right. Thus, we apply for a pledge donation which funds a greenhouse gas reduction plantation project. Thank you.”, and the requester's name “ZZZZ COMPANY.”

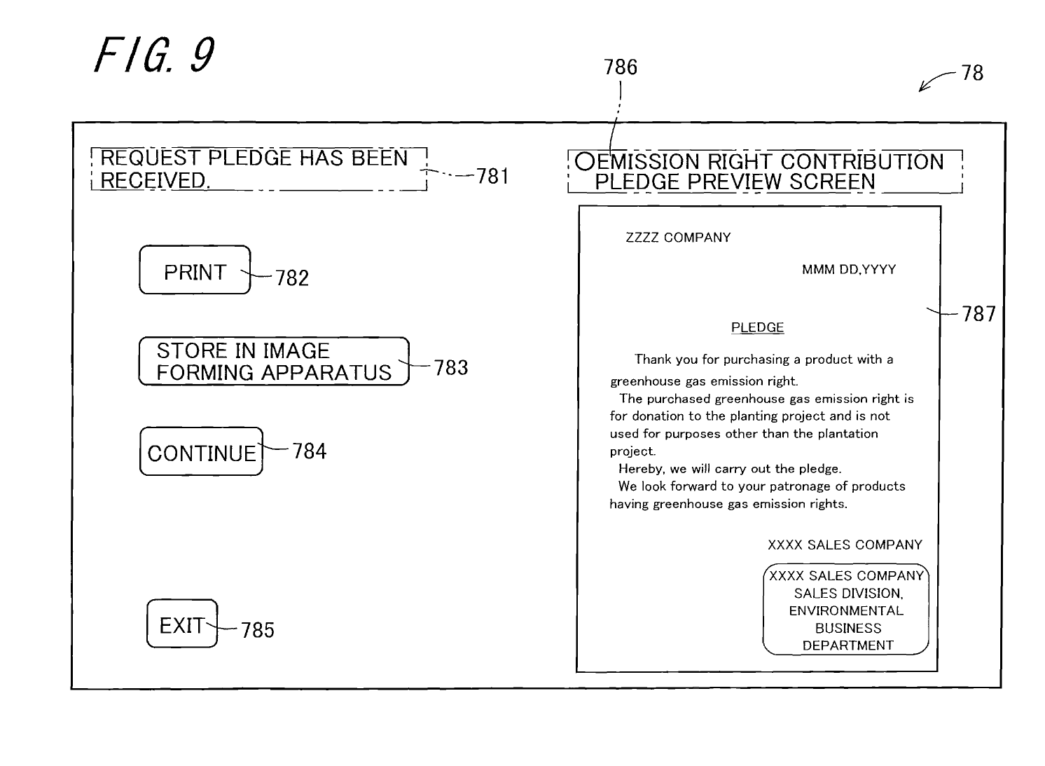

When the control unit 501 is informed of a user's manipulation of the “CONFIRM PLEDGE INVOICE” icon 772 and the “SEND PLEDGE INVOICE” icon 773 from the input unit 505, the control unit 501 creates a pledge invoice and sends the created pledge invoice to the server 101 through the connection unit 506. When the pledge invoice is received, the server 101 creates a pledge and sends the created pledge to the image forming apparatus 1. The control unit 501 performs control such that the received pledge is displayed on a pledge receive screen 78 as shown in FIG. 9 as the pledge is received from the server 101 through the connection unit 506.

FIG. 9 is a diagram illustrating an example of the pledge receiving screen 78. The pledge receiving screen 78 includes a pledge receiving field 781, a “PRINT” icon 782, a “STORE IN IMAGE FORMING APPARATUS” icon 783, a “CONTINUE” icon 784, an “EXIT” icon 785, a pledge receiving preview title field 786, and a pledge receiving preview screen field 787.

The pledge receiving message field 781 is a message field for indicating that the pledge has been received, and in FIG. 9, “REQUESTED PLEDGE HAS BEEN RECEIVED” is illustrated. The “PRINT” icon 782 is a manipulation icon for printing the received pledge. The “STORE IN IMAGE FORMING APPARATUS” icon 783 is a manipulation icon for storing the received pledge in the storage unit 502. The “CONTINUE” icon 784 is a manipulation icon for continuing the pledge application.

The “EXIT” icon 785 is a manipulation icon for terminating the pledge application process. The control unit 501 performs control such that an initial screen is displayed on the display unit 504 when the “EXIT” icon 785 is manipulated.

The pledge receiving preview title field 786 is a field for indicating the title of the preview image displayed in the pledge receiving preview screen field 787, and in FIG. 9, “o EMISSION RIGHT CONTRIBUTION PLEDGE PREVIEW SCREEN” is illustrated. The pledge receiving preview screen field 787 is a screen field for indicating the pledge as a preview image. The preview image displayed in the pledge receiving preview screen field 787 as shown in FIG. 9 shows a destination “ZZZZ COMPANY”, application receipt data “MMM DD, YYYY”, Document title “PLEDGE”, a body “Thank you for purchasing a product with a greenhouse gas emission right. The purchased greenhouse gas emission right is for donation to the planting project and is not used for purposes other than the plantation project. Hereby, we will carry out the pledge. We look forward to your patronage of products having greenhouse gas emission rights.”, and the pledge issuer's name “XXXX SALES COMPANY (XXXX SALES COMPANY, SALES DIVISION, ENVIRONMENTAL BUSINESS DEPARTMENT).”

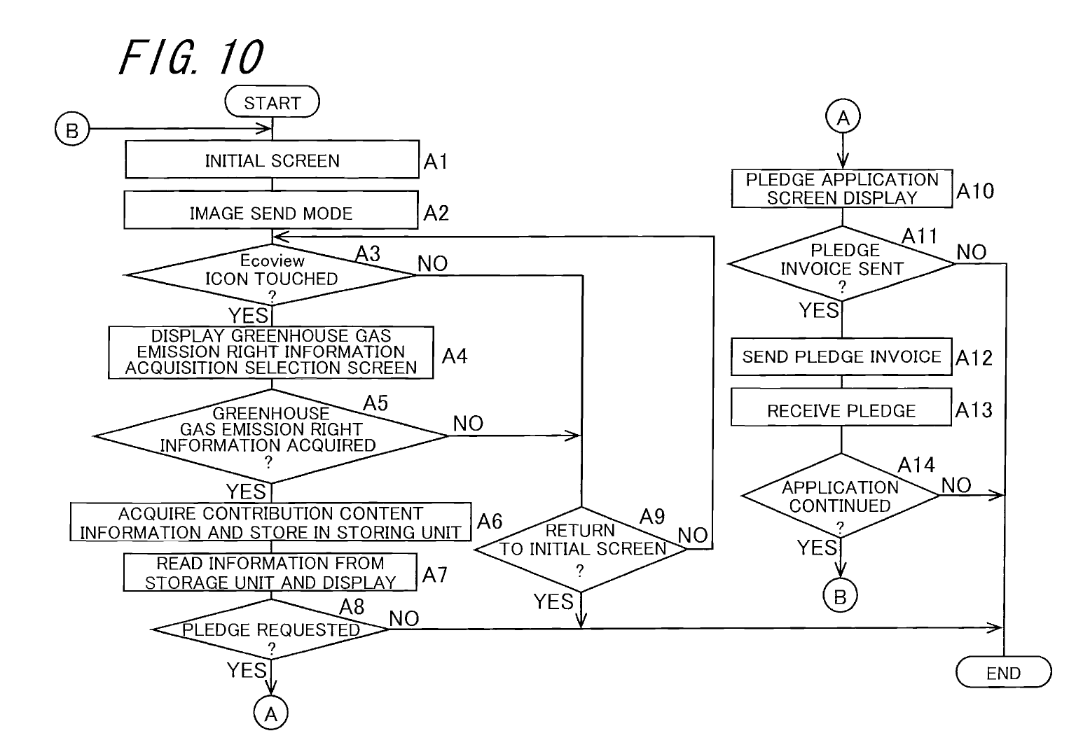

FIG. 10 is a flowchart illustrating a processing sequence for the confirmation process of the greenhouse gas emission right contribution content executed in the communication system 100.

When the image forming apparatus 1 and the server 101 are powered up, and all of them are operable, the process proceeds to step A1.

In step A1, the control unit 501 causes the display unit 504 to display an initial screen. In the initial screen, the main menu icons including the “IMAGE SEND” icon 711 are displayed. When a user manipulates the “IMAGE SEND” icon 711, the process proceeds to step A2. In step A2, the control unit 501 sets a mode of the image forming apparatus 1 to an “IMAGE SEND” mode and causes the display unit 504 to display the IMAGE SEND initial screen 71 as shown in FIG. 4B.

In step A3, the control unit 501 determines whether or not the “Ecoview” icon 712 is touched. If the “Ecoview” icon 712 is manipulated, it is determined that the “Ecoview” icon 712 is touched, and the process proceeds to step A4. If the “Ecoview” icon 712 is not manipulated, it is determined that the “Ecoview” icon 712 is not touched, and the process proceeds to step A9.

In step A4, the selection screen 72 of FIG. 5 is displayed on the display unit 504. Then, in step A5, the control unit 501 determines whether or not the greenhouse gas emission right information is acquired. More particularly, when the device desired to acquire the emission right information is selected on the selection screen 72 and the “SEND” icon 726 is manipulated, the control unit 501 determines that a greenhouse gas emission right information is acquired, and the process proceeds to step A6. When the device desired to acquire the emission right information is not selected at the selection screen 72, or when the “SEND” icon 726 is not manipulated, it is determined that the greenhouse gas emission right information is not acquired, and the process proceeds to step A9.

In step A6, the control unit 501 acquires the contribution content information and stores the acquired contribution content information in the storage unit 502. More particularly, the control unit 501 requests the contribution content information to the server 101 through the connection unit 506. The server 101 reads the contribution content information stored in the server storage unit when the contribution content information is requested from the image forming apparatus 1, and sends the read contribution content information to the image forming apparatus 1. If the contribution content information is received through connection unit 506, the control unit 501 stores the received contribution content information in the storage unit 502.

Then, in step A7, the control unit 501 reads the contribution content information from the storage unit 502 and causes the display unit 504 to display the display screen 76 of the contribution content information of FIG. 7.

Then, in step A8, the control unit 501 determines whether or not a pledge is requested. More particularly, when a user manipulates the “NEXT” icon 768 on the display screen 76 of the contribution content information, the control unit 501 determines that the pledge is requested, and the process proceeds to step A10. When a user does not manipulate the “NEXT” icon 768 on the display screen 76 of the contribution content information but manipulates the “RETURN” icon 767, the control unit 501 determines that the pledge is not requested and terminates the greenhouse gas emission right contribution content confirmation process.

In step A9, the control unit 501 determines whether or not a return is made to the initial screen. If it is determined that a return is made to the initial screen, the greenhouse gas emission right contribution content confirmation process is terminated. Otherwise, if it is determined that the initial screen is not returned, the process returns to step A3.

In step A10, the control unit 501 causes the display unit 504 to display the pledge application screen 77 as shown in FIG. 8.

Then, in step A11, the control unit 501 determines whether or not a pledge invoice is sent. More particularly, when a user manipulates the “SEND PLEDGE INVOICE” icon 773 on the pledge application screen 77, the control unit 501 determines that the pledge invoice is sent, and the process proceeds to step A12. When a user does not manipulate the “SEND PLEDGE INVOICE” icon 773 on the pledge application screen 77 but manipulates the “RETURN” icon 774, the “RETURN TO IMAGE SEND SCREEN” icon 775, or the “RETURN TO INITIAL SCREEN” icon 776, the control unit 501 determines that the pledge invoice is not sent and terminates the greenhouse gas emission right contribution content confirmation process.

In step A12, when a user manipulates the “SEND PLEDGE INVOICE” icon 773 in the pledge application screen 77, the control unit 501 sends the pledge invoice to the server 101. In the next step A13, the control unit 501 receives the pledge sent from the server 101 in response to a pledge invoice and causes the display unit 504 to display the pledge receiving screen 78 as shown in FIG. 9.

In step A14, the control unit 501 determines whether or not application of the pledge is continued. When a user manipulates the “CONTINUE” icon 784 on the pledge receiving screen 78, the control unit 501 determines that application of the pledge is continued, and the process proceeds to step A1. When a user does not manipulate the “CONTINUE” icon 784 on the pledge receiving screen 78 but manipulate the “EXIT” icon 785, it is determined that application of the pledge is not continued, and the greenhouse gas emission right contribution content confirmation process is terminated.

In addition, the greenhouse gas emission right contribution content confirmation process may be performed until the ready state capable of printing after the warm-up of the image forming apparatus 1 or may be performed between print jobs. In either time interval, by performing the greenhouse gas emission right contribution content confirmation process, for example, it is possible to obtain an effect whereby there is no interference when other users use the image forming apparatus 1.

According to the embodiment, the display unit 504 may include a liquid crystal display, an organic EL display, a plasma display, a plasma tube array display, an electronic sheet display including an electrophoresis type, and an electron emission display.

In addition, the display unit 504 of the embodiment may be applied to products developed on the premise of uses other than in general households such as business equipment (corporations (companies or schools, government agencies)) and consumer equipment (electronic devices and equipment related to audiovisual and communications, or in a terminal, those intended for home use or the general consumer use, or refer to the product/specifications that are developed/designed on such a premise).

In the communication system 100 according to the embodiment, in a case where the consumables are determined as a regular greenhouse gas emission right-granted consumables by determining that emission right allowance information is recorded in the recording unit of the consumables mounted on the image forming apparatus main body 3 by the computation unit 503, the image forming apparatus 1 acquires the contribution content information regarding greenhouse gas reduction corresponding to the emission right allowance information from the server 101 through the connection unit 506 and displays the acquired contribution content information on the display unit 504. Therefore, it is possible to allow a user to identify the contribution content information and promote the purchase of the greenhouse gas emission right-granted consumables.

The technology is not limited to the exemplary embodiments described above, but various modifications can be made within the scope of the appended claims, and embodiments derived from arbitrary combination of the technical solution respectively disclosed in the different exemplary embodiments are also within the technical scope of the technology.

The technology may be embodied in other specific forms without departing from the spirit or essential characteristics thereof. The present embodiments are therefore to be considered in all respects as illustrative and not restrictive, the scope of the technology being indicated by the appended claims rather than by the foregoing description and all changes which come within the meaning and the range of equivalency of the claims are therefore intended to be embraced therein.

1. (canceled)

2. An image forming apparatus communicatively connected with an external apparatus, the external apparatus storing contribution content information representing a contribution content regarding greenhouse gas reduction of consumables used in the image forming apparatus, the image forming apparatus comprising:
a unit configured to, when it is determined that the consumables mounted on the image forming apparatus hold emission right allowance information of a greenhouse gas, acquire the contribution content information from the external apparatus.

3. The image forming apparatus of claim 2, wherein the contribution content information stored in the external apparatus is information on planting of trees absorbing the greenhouse gas.

4. The image forming apparatus of claim 3, wherein the information on planting of trees absorbing the greenhouse gas is information on planting of mangroves.

5. The image forming apparatus of claim 2, wherein the image forming apparatus includes an input unit configured to input an instruction regarding data communication with the external apparatus, and
the image forming apparatus acquires the contribution content information from the external apparatus based on the instruction inputted from the input unit.

6. The image forming apparatus of claim 5, wherein the image forming apparatus and the external apparatus are data-communicatively connected via a communication network.

7. The image forming apparatus of claim 2, wherein the consumables have a recording unit selected from a memory including an integrated circuit, and a one-dimensional or two-dimensional code image obtained by encoding the emission right allowance information.

8. The image forming apparatus of claim 2, wherein a carbon footprint mark is affixed to the consumables which are determined that the emission right allowance information is held.

9. An image forming apparatus communicatively connected with an external apparatus, the image forming apparatus comprising:
a unit configured to:
acquire contribution content information representing a contribution content regarding greenhouse gas reduction of consumables used in the image forming apparatus, and
display acquired contribution content information on a display.

10. The image forming apparatus of claim 9, wherein the unit displays a part of the acquired contribution content information and an operation part which enables display of the part of the acquired contribution content information to move on the display.

11. The image forming apparatus of claim 9, wherein the contribution content information includes information on contribution to the greenhouse gas reduction.

12. The image forming apparatus of claim 11, wherein the information on contribution to the greenhouse gas reduction is a carbon dioxide emission reduction amount.
